(19) United States
(12) Patent Application Publication
(10) Pub. No.: US 2022/0282026 A1
(43) Pub. Date: Sep. 8, 2022

(54) POLYISOCYANATE AND PROCESS FOR PREPARING THE SAME

(71) Applicant: Covestro Intellectual Property GmbH & Co. KG, Leverkusen (DE)

(72) Inventors: Hongchao Li, Shanghai, Pudong (CN); Zhe Zhu, Shanghai, Hongkou District (CN); Jingmei Liu, Shanghai, Pudong District (CN); Pingbo Ding, Wuhan, Dongxi Hu District (CN); Yuefeng Wang, Shanghai, Minhang District (CN); Ruiwen Wu, Leverkusen (DE); Robert Maleika, Düsseldorf (DE)

(21) Appl. No.: 17/632,544

(22) PCT Filed: Aug. 6, 2020
(86) PCT No.: PCT/EP2020/072090

§ 371 Date: Feb. 3, 2022

(30) Foreign Application Priority Data
Aug. 9, 2019 (CN) 201910738766.2
Oct. 7, 2019 (EP) 19201654.1

(51) Int. Cl. C08G 18/76; C08G 18/32; C08G 18/12; C09D 175/04; C09J 175/04

(52) U.S. Cl. CPC C08G 18/7621; C08G 18/3206; C08G 18/12; C09D 175/04; C09J 175/04

(57) ABSTRACT

The present invention relates to a urethane group-containing polyisocyanate prepared by reacting a system containing organic polyhydroxy compounds and excess toluene diisocyanate and, a process for preparing the same, a product containing the polyisocyanate, and the use thereof as a polyisocyanate component in a polyurethane paint and a polyurethane adhesive. The polyisocyanate has the following characteristics: a. the ratio of the integral area of the component peaks having a. weight-average molecular weight of 800±50 to the integral area of the shoulder peaks having a weight-average molecular weight of 950±50 is 2-14; and b. the viscosity is not higher than 2500 mPa·s. The polyisocyanate of the present invention has a good storage stability.

### TECHNICAL FIELD

The present invention relates to a urethane group-containing polyisocyanate prepared by reacting a system containing organic polyhydroxy compounds and excess toluene diisocyanate, a process for preparing the same, a product containing the same, and use thereof as a polyisocyanate component in a polyurethane paint.

### BACKGROUND TECHNIQUE

A polyisocyanate having a urethane group derived from organic polyhydroxy compounds, in particular, lower-molecular weight organic polyhydroxy compounds and toluene diisocyanate (TDI) has been well known for a long time, for example, polyisocyanates described in DE 870 400, DE953 012 and DE 1 090 196. This kind of polyisocyanate is very important in the field of polyurethane paints (also known as polyurethane coatings) and polyurethane adhesives, in particular, wood coatings as well as adhesives. DE-PS 1090 186 and U.S. Pat. No. 3,183,112 describe the preparation of the commercially available polyisocyanate products, e.g., Desmodur L75 EA, by reacting polyhydroxy compounds with a 5 to 10 times molar amount of toluene diisocyanate, followed by removing the excess starting diisocyanate by separation in a thin film evaporator, and then the addition of the corresponding solvent. CN1793194A also discloses a separation technology for free isocyanate monomer in a polyurethane curing agent.

In the actual use of the above polyisocyanates, some products sometimes exhibit agglomeration or even solid precipitation in the product solution after being used or stored for a period of time, especially at lower storage temperature. Although after being heated and stirred for a period of time, the above products containing agglomeration or even solid precipitation will change into a clear solution again without affecting the quality and performance of the product, however, the additional heating treatment operation affects the ease of use of the product, thus avoiding the agglomeration or even solid precipitation of the product during storage is a challenge for polyisocyanate producers.

CN109824865A discloses a process for preparing a storage stable polyurethane curing agent. The high molecular weight polymer components are considered to cause the deterioration of storage stability. Therefore, after the excess toluene diisocyanate reacts with hydroxy compounds, organic acids having a pKa value of 1 to 15 are added to the reaction mixture, and then the excess toluene diisocyanate monomer is separated at a high temperature by a thin-film evaporator. The added organic acids are believed to promote the reaction of free hydroxyl groups with highly reactive isocyanate groups in the reaction mixture during the thin film evaporation, to reduce the residual hydroxyl content of the prepared curing agent, and to increase the storage stability of the curing agent. However, the addition of organic acids such as dibutyl phosphate not only increases the process complexity and the raw material cost, but also limits the application of the curing agents. For example, such curing agent might not be proper for food contact.

CN1793194A improves the storage stability of a curing agent by additionally adding a high molecular weight polyethylene glycol 200 to low molecular weight organic polyhydroxy compounds. It is generally understood in the industry that high molecular weight polyethylene glycol 200 reacts with toluene diisocyanate to form a component having a higher molecular weight, and may cause increase of viscosity and decrease of the isocyanate group content, which are disadvantages for industrial applications. Moreover, the increase of the types of raw material components will increase the process complexity and the raw material cost.

Therefore, the development of polyisocyanates with low viscosity and good storage stability without increasing the raw material components and the process complexity is still urgently needed in the polyurethane industry.

### SUMMARY OF THE INVENTION

The term “curing” refers to a process of changing from a liquid state to a solid state of the paint or adhesive.

The term “adhesive” refers to a mixture comprising a curable and viscous chemical component and is also used as a synonym for binder and/or sealant and/or glue.

The term “polyurethane” means polyurethane urea and/or polyurethane polyurea and/or polyurea and/or polythiourethane.

The term “toluene diisocyanate” refers to a collective name for 2,4-toluene diisocyanate, 2,6-toluene diisocyanate and a mixture of 2,4-toluene diisocyanate and 2,6-toluene diisocyanate.

The polyisocyanate of the present invention is actually in the form of a solution, wherein the solvent can be those known in the art.

It is an object of the present invention to provide a urethane group-containing polyisocyanate prepared by reacting a system containing organic polyhydroxy compounds and excess toluene diisocyanate, a process for preparing the same, a product containing the same, and use thereof as a polyisocyanate component in a polyurethane paint.

According the present invention, the urethane group-containing polyisocyanate prepared by reacting a system containing organic polyhydroxy compounds and excess toluene diisocyanate, wherein the organic polyhydroxy compounds contain trimethylolpropane and optionally di- to tetra-hydric alcohols having a molecular weight of 62-146 g/mol, characterized in that:

a. the ratio of the integral area of the component peaks having a weight-average molecular weight of 800±50 g/mol to the integral area of the shoulder peaks having a weight-average molecular weight of 950±50 g/mol is 2-14; and

b. the viscosity is not higher than 2500mPa·s.

According to one aspect of the invention, a process for preparing a polyisocyanate is provided, comprising:

i. reacting a system containing organic polyhydroxy compounds and excess toluene diisocyanate to produce a pre-polymer reaction mixture, the reaction temperature is 85° C.-120° C., the reaction time is 1 hour to 24 hours;

ii. removing the unreacted toluene diisocyanate by separation from the pre-polymer reaction mixture obtained in step i; and

iii. adding organic solvents to dilute and to produce the polyisocyanates.

According to one aspect of the invention, a product comprising the polyisocyanate is provided.

According to one aspect of the invention, the use of the polyisocyanate as a polyisocyanate component in a polyurethane paint is provided.

According to one aspect of the invention, the use of the polyisocyanate as a polyisocyanate component in a polyurethane adhesive is provided .

The urethane group-containing polyisocyanate of the present invention, prepared by reacting a system containing organic polyhydroxy compounds and excess toluene diisocyanate, not only has high content of isocyanate groups, low content of monomer toluene diisocyanate and low viscosity, but also has the advantage of being not prone to agglomerate, that is, a good storage stability, for a long period of storage time.

The paint films formed by the polyurethane paint containing the polyisocyanate of the present invention and in particular formed by the two-component polyurethane paint containing the polyisocyanate of the present invention as a crosslinking agent have high abrasion resistance and excellent adhesion property on a variety of different substrates. The paint films are hard but still elastic, and the paint films are not easily discolored. The texture of the light-colored woods painted therewith can also be obviously effective.

### DESCRIPTION OF THE DRAWINGS

The invention will be illustrated and explained in more detail below with reference to the drawings, in which:

FIG. 1 is a Gel Permeation Chromatography (GPC) obtained from polyisocyanate 5 of Example 5. FIG. 1 also shows the calculation of the ratio of the integral area of the component peaks having a weight-average molecular weight of 800±50 g/mol to the integral area of the shoulder peaks having a weight-average molecular weight of 950±50 g/mol of polyisocyanate 5.

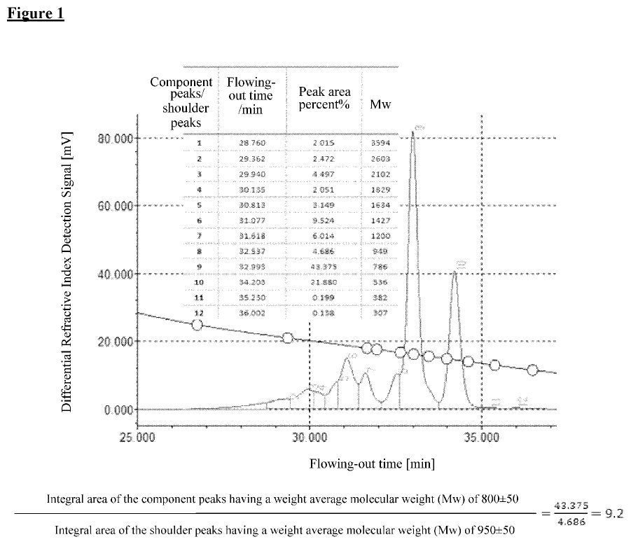

### DETAILED DESCRIPTION OF THE PRESENT INVENTION

The present invention provides a urethane group-containing polyisocyanate prepared by reacting a system of organic polyhydroxy compounds and excess toluene diisocyanate, wherein the organic polyhydroxy compounds contain trimethylolpropane and optionally di- to tetra-hydric alcohols having a molecular weight of 62-146 g/mol, the polyisocyanate has the following characteristics: a. the ratio of the integral area of the component peaks having a weight-average molecular weight of 800±50 g/mol to the integral area of the shoulder peaks having a weight-average molecular weight of 950±50 g/mol is 2-14; and b. the viscosity is not higher than 2500 mPa·s. The present invention also provides a process for preparing the polyisocyanate, a product containing the same, and use thereof as a polyisocyanate component in a polyurethane paint and adhesive.

Polyisocyanate

The ratio of the integral area of the component peaks having a weight-average molecular weight of 800±50 g/mol to the integral area of the shoulder peaks having a weight-average molecular weight of 950±50 g/mol is preferably 3-13, further preferably 4-12, most preferably 6-12.

The polyisocyanate component of the present invention and the weight-average molecular weight thereof are determined according to DIN 55672-1:2016-03 with a HLC-8320 EcoSEC-type gel chromatograph from TOSOH, using polystyrene standard and high performance universal chromatographic column, a group of 4 columns (TSKgel G2000HXL, TSKgel G2500HXL, TSKgel G3000HXL and TSKgel G4000HXL, the chromatographic column packing material is a styrene-divinylbenzene copolymer) and a differential refraction detector, using THF as eluent, a flow rate of 1.0 ml/min, a pressure of 6.4 MPa and a column temperature of 40° C.

The viscosity of the polyisocyanate is preferably not higher than 2000 mPa·s, most preferably not higher than 1800 mPa·s. The viscosity is measured according to DIN EN ISO 5:1994-10 using a cone/plate measuring instrument at 23° C.

Preferably the viscosity of the polyisocyanate is 2000 mPa·s or less, and the ratio of the integral area of the component peaks having a weight-average molecular weight of 800±50 g/mol to the integral area of the shoulder peaks having a weight-average molecular weight of 950±50 g/mol is 4-12.

Most preferably the viscosity of the polyisocyanate is 1800 mPa·s or less, and the ratio of the integral area of the component peaks having a weight-average molecular weight of 800±50 g/mol to the integral area of the shoulder peaks having a weight-average molecular weight of 950±50 g/mol is 6-12.

The polyisocyanate preferably further has one or more of the following characteristics:

c. the solid content is not lower than 50 wt % and not higher than 90 wt %;

d. the amount of the unreacted excess toluene diisocyanate is not higher than 0.5 wt %; and

e. the isocyanate group content is 13 wt %-15 wt %;

all of the above weight percent numbers are based on the total weight of the polyisocyanate being 100 wt %.

The solid content of the polyisocyanate is preferably 60 wt %-80 wt %, further preferably 70 wt %-77 wt %, most preferably 73 wt %-77 wt %, based on the total weight of the polyisocyanate being 100 wt %.

The solid content (also referred to as the non-volatile content) is determined according to DIN EN ISO 3251 using the drying temperature of 120° C., the drying time of 2 hours, the test vessel diameter of 75 mm and the sample weight of 2.00+/−0.02 g.

The amount of the unreacted excess toluene diisocyanate of the polyisocyanate is preferably not higher than 0.4 wt %, based on the total weight of the polyisocyanate being 100 wt %.

The content of the unreacted excess toluene diisocyanate is determined by gas chromatography according to DIN EN ISO 10283:2007-11 using an internal standard.

The polyisocyanate of the present invention contains a low level of the unreacted excess toluene diisocyanate, which improves occupational hygiene, particularly occupational hygiene in manual operation, and extends the application field of the polyisocyanate of the present invention.

The analysis results from the GPC indicate that multiple polyisocyanate components are simultaneously present in the polyisocyanate of the present invention, and the specific components depend on the used organic polyhydroxy compounds and the toluene diisocyanate (TDI) content. Among others, the main component is formed by reacting a single organic polyhydroxy compound in the system with a TDI molecule corresponding to its functionality number; in addition to the main component, higher molecular weight components formed by continuing to react two or more organic polyhydroxy compounds in the system with TDI and the main component are included. We have surprisingly found that a shoulder peak sometimes appears on the high molecular weight side of the GPC peak of a component formed by reacting a single organic polyhydroxy compound with a TDI molecule corresponding to its functionality number, and it is surprisingly found that the shoulder peak also contributes to increase the isocyanate group content of the polyisocyanate and to improve the storage stability of the polyisocyanate without significantly increasing the viscosity of the polyisocyanate. In particular, for the polyisocyanate formed by the reaction of trimethylolpropane and TDI, the ratio of the integral area of the component peaks having a weight-average molecular weight (Mw) of 800±50 g/mol to the integral area of the shoulder peaks having a weight-average molecular weight of 950±50 g/mol in the GPC will affect the storage stability of the polyisocyanate product.

Toluene Diisocyanate

The toluene diisocyanate is preferably a mixture of 2,4-toluene diisocyanate and 2,6-toluene diisocyanate, wherein the weight ratio of 2,4-toluene diisocyanate to 2,6-toluene diisocyanate is 60:40-95:5, preferably 65:35-90:10, most preferably 70:30-85:15.

The toluene diisocyanate is preferably prepared by the gas phase phosgenation.

2-chloro-6-isocyanato-methyl cyclohexadiene (CIMCH) can be in the form of three double bond isomers which can be present in the TDI in different ratios. These are formed, for example, in TDI production from 1-amino-2-methyl-cyclohexenone contained in the TDA used, which in turn can form in the production of TDA from dinitrotoluene (DNT) by partial nuclear hydrogenation of TDA and replacement of an amino functional group by water. It is also possible that the keto functional group is already introduced proportionately by oxidative attack in the production of DNT by nitration of toluene, there first being formed nitrocresols which can then form the above-described 1-amino-methyl-2-cyclohexenone in the subsequent hydrogenation.

The toluene diisocyanate have a content of 2-chloro-6-isocyanato-methylcyclohexadienes (CIMCH) of <5 wt. ppm, preferably of <3 wt. ppm. Such TDI grades can be obtained, for example, by purposive removal of 2-chloro-6-isocyanato-methylcyclohexadienes from the preconcentrated crude TDI solutions by distillation by means of a dividing wall distillation column, as is described in EP I 413 571 B1. Particular preference is given, however, to toluene diisocyanates which are produced by gas phase phosgenation of TDA and whose content of 2-chloro-6-isocyanato-methylcyclohexadienes is below 1 ppm the detection limit. Toluene diisocyanate of such a grade is obtainable, for example, from the Caojing production site of Covestro Deutschland AG, China.

Two independent analytical methods have been used for the clear characterization of the component 2-chloro-6-isocyanato-methylcyclohexadienes. By means of gas chromatography techniques, different toluene diisocyanate grades having a 2,4 content of about 80 wt. % were tested for their dissimilarities in the secondary component spectrum. By subsequent coupled gas chromatography-mass spectroscopy, a molecular weight of 169 g/mol was allocated to the three hitherto unknown compounds (CIMCH including two isomers). It was possible to obtain further structural information from the fragmentation in a manner known to the person skilled in the art. By means of complex nuclear resonance spectroscopy experiments ('H-NMR, 'H-COSY, 'H-, 'HTOCSY and 'H-, 'C-HMBC), the structures indicated below could be allocated to the three components with m/z 169.

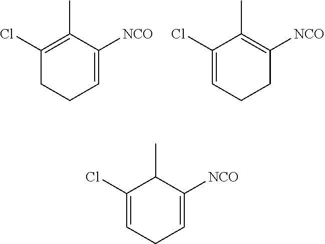

By purposive method development it was possible to set the detection limit of the isomers of CIMCH by means of gas chromatography-spectroscopy, using an Optima 5 HT column (60 m length, 0.25 mm inside diameter, 0.25 μm film thickness) from Macherey-Nagel in an HP Series 6890 gas chromatograph from Hewlett Packard, at 1 wt. ppm.

An Isocyanate Compound Different from the Toluene Diisocyanate

The system may further comprises an isocyanate compound different from the toluene diisocyanate, the weight ratio of the toluene diisocyanate to the isocyanate compound different from the toluene diisocyanate is preferably not lower than 60:40, further preferably not lower than 90:10, most preferably not lower than 95:5.

The isocyanate compound different from the toluene diisocyanate in the system may be any other compounds having an isocyanate group, such as a monoisocyanate having an aliphatic, alicyclic, araliphatic or aromatic bonded isocyanate group, a diisocyanate having an aliphatic, alicyclic, araliphatic and/or aromatic bonded isocyanate group, a triisocyanate and/or a higher functionality isocyanate, and a modified isocyanate derived from the above-mentioned diisocyanate and triisocyanate and prepared by oligomerization e.g. trimerization.

The monoisocyanate having an aliphatic, alicyclic, araliphatic or aromatic bonded isocyanate group is preferably one or more of the following: stearyl isocyanate and naphthyl isocyanate.

The diisocyanate having an aliphatic, alicyclic, araliphatic and/or aromatic-bonded isocyanate group is preferably one or more of the following: 1,4-diisocyanatobutane, 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-di(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-1-methyl-4(3)-isocyanatomethyl cyclohexane (IMCI), di(isocyanatomethyl)norbornane, 2,4′- and 4,4′-diisocyanatodiphenylmethane and higher homologs, 1,5-diisocyanato naphthalene and dipropylene glycol diisocyanate.

The triisocyanate and/or the higher functionality isocyanate is preferably one or more of the following: 4-isocyanatomethyloctane-1,8-diisocyanate (nonane triisocyanate) and undecane-1,6,11-triisocyanate.

The isocyanate compound different from the toluene diisocyanate in the system is most preferably one or more of the following: 1,5-diisocyanatopentane (PDI), 1,6-diisocyanatohexane (HDI) and a modified isocyanate derived from the above-mentioned diisocyanate and prepared by oligomerization e.g. trimerization.

When the system comprises both toluene diisocyanate and the isocyanate compound different from the toluene diisocyanate, the total amount of any unreacted monomeric isocyanates still present (i.e., the sum of the amount of unreacted excess toluene diisocyanate and the amount of unreacted excess isocyanate compound different from the toluene diisocyanate) is preferably not higher than 0.5 wt %, further preferably not higher than 0.4 wt %, based on the total weight of the polyisocyanate being 100 wt %.

The content of the unreacted excess monomeric toluene diisocyanate and the content of the unreacted excess isocyanate compound different from the toluene diisocyanate are determined by gas chromatography according to DIN EN ISO 10283:2007-11 using an internal standard.

Organic Polyhydroxy Compound

The total weight of the trimethylolpropane and the optional di- to tetra-hydric alcohols having a molecular weight of 62-146 g/mol is preferably 99.7 wt %-100 wt %, most preferably 100 wt %, based on the total weight of the organic polyhydroxy compounds being 100 wt %.

The weight ratio of the trimethylolpropane to the di- to tetra-hydric alcohols having a molecular weight of 62-146 g/mol is preferably 1:4-4:1, further preferably 3:7-3:1, most preferably 1:1-7:3.

The di- to tetra-hydric alcohol having a molecular weight of 62-146 g/mol is preferably one or more of the following: ethylene glycol, diethylene glycol, 1,2-propylene glycol, 1,3-propylene glycol, 1,2-butylene glycol, 1,3-butylene glycol, 1,4-butylene glycol, 1,5-pentylene glycol, neo-pentylene glycol, 1,6-hexylene glycol, 2-ethyl hexylene glycol, glycerol and pentaerythritol, most preferably diethylene glycol.

The di- to tetra-hydric alcohol having a molecular weight of 62-146 g/mol is most preferably diethylene glycol, the weight ratio of trimethylolpropane to diethylene glycol is preferably 1:4-4:1, further preferably 3:7-3:1, most preferably 1:1-7:3.

Process

A process for preparing the polyisocyanate of the present invention comprises:

i. reacting a system containing organic polyhydroxy compounds and excess toluene diisocyanate to produce a pre-polymer reaction mixture, the reaction temperature is 85° C.-120° C., the reaction time is 1 hour to 24 hours;

ii. removing the unreacted toluene diisocyanate by separation from the pre-polymer reaction mixture obtained in step i; and

iii. adding organic solvents to dilute and to produce the polyisocyanates;

wherein, the organic polyhydroxy compound contains trimethylolpropane and an optional di- to tetra-hydric alcohols having a molecular weight of 62-146 g/mol; the polyisocyanate has the following characteristics:

a. the ratio of the integral area of the component peaks having a weight-average molecular weight of 800±50 g/mol to the integral area of the shoulder peaks having a weight-average molecular weight of 950±50 g/mol is 2-14; and

b. the viscosity is not higher than 2500 mPa·s.

In step i, the reaction temperature is preferably 85° C.-110° C., most preferably 90° C.-98° C.

In step i, the reaction time is preferably 1.2 hours to 7 hours, most preferably 1.2 hours to 4 hours. The reaction time in step i of the present invention includes the time for mixing the organic polyhydroxy compounds with toluene diisocyanate and the time for reacting of the system at the reaction temperature.

The equivalent ratio of the isocyanate group to the hydroxy group of the system is preferably 3:1-20:1, further preferably 3.5:1-10:1, most preferably 3.8:1-8:1.

The separation of step ii is preferably distillation.

Preferably, specifically in step ii, the pre-polymer reaction mixture is distilled through a thin film evaporator at 100° C.-180° C. at vacuum, preferably 120° C.-170° C. to remove unreacted excess toluene diisocyanate to obtain a semi-hard to hard product crude.

Specifically in step iii, organic solvents is added to the semi-hard to hard product crude obtained in step ii to dilute and to produce the polyisocyanate.

The organic solvent may be those known in the industry, such as toluene, xylene, cyclohexane, butyl acetate, ethyl acetate, ethylene glycol acetate (ethyl glycol acetate), pentyl acetate, hexyl acetate, methoxypropyl acetate, tetrahydrofuran, dioxane, acetone, N-methylpyrrolidone, methyl ethyl ketone, solvent naphtha, higher substituted aromatic compounds (such as those commercially available under the trade marks Solvent Naphtha®, Solvesso®, Shellsol®, Isopar®, Nappar® and Diasol®), benzene homologues, tetralin, decalin and alkanes with more than 6 carbon atoms, conventional plasticizers such as phthalates, sulfonates and phosphates and mixtures of such diluents and solvents. Further suitable solvents are aliphatic diisocyanate-based polyisocyanates as described, for example, in DE-A 4 428 107, which render the polyisocyanate free of volatile solvents and diluents or to contain less volatile solvents and diluents.

The organic solvent is preferably added in such an amount as to be able to set the solid content of the polyisocyanate to be 50 wt %-90 wt %, more preferably 60 wt %-80 wt %, further preferably 70 wt %-77 wt %, most preferably 73 wt %-77 wt %.

The method can be carried out batchwise or continuously.

Product

The product is preferably selected from a group consisting of polyurethane paints and polyurethane adhesives.

The polyurethane paint may be a one-component polyurethane paint or a two-component polyurethane paint.

The two-component polyurethane paint may comprise the polyisocyanate of the invention, and one or more of the following known in the polyurethane paint technology: polyesters polyols, polyethers polyols, polyacrylates polyols, and optional low molecular weight polyols.

The two-component polyurethane paint may also comprise the polyisocyanate of the invention and one or more of the following: a blocked polyketimine and a polyamine of an oxazolidine, wherein the equivalent ratio of the isocyanate group to the isocyanate-reactive group is 0.8:1-3.0:1, preferably 0.9:1-1.1:1.

The two-component polyurethane paint may further comprise a catalyst. The catalyst is used to accelerate the curing of the polyurethane paint.

The catalyst may be those known in the art, such as an amine such as triethylamine, pyridine, picoline, benzyldimethylamine, N,N′-dimethylpiperazine or a metal salt such as ferric chloride (III), zinc chloride, zinc 2-ethylhexanoate, stannum (II) 2-ethylhexanoate, dibutyl stannum (IV) dilaurate or molybdenum glycolate.

The one-component polyurethane paint or two-component polyurethane paint comprising the polyisocyanate of the present invention is capable of forming a hard and still elastic paint film with excellent adhesion property on a variety of different substrates. The paint film also has the advantages of high abrasion resistance and being not easily discolored, and is suitable for the field of wooden ware, particularly suitable for the field of wooden ware using light-colored wood.

### EXAMPLE

Unless otherwise defined, all technical and scientific terms used herein have the same meaning as commonly understood by those skilled in the art to which this invention belongs. When the definition of a term in this specification conflicts with the meaning commonly understood by those skilled in the art to which the invention belongs, the definitions described herein shall prevail.

Unless otherwise stated, all numbers expressing quantities of ingredients, reaction conditions and the like used in the specification and claims are understood to be modified by the term “about”. Therefore, unless indicated to the contrary, the numerical parameters set forth herein are approximations that can be varied as desired.

As used herein, “and/or” refers to one or all of the elements mentioned.

As used herein, “not lower than” and “not higher than” encompass the recited values themselves, unless otherwise indicated.

As used herein, “comprising” and “containing” encompass the presence of only the recited elements and the presence of other unmentioned elements in addition to the elements mentioned.

The analytical measurements of the present invention are carried out at 23° C. unless otherwise stated.

The polyisocyanate component of the present invention and the weight-average molecular weight thereof are determined according to DIN 55672-1:2016-03 with a HLC-8320 EcoSEC-type gel chromatograph from TOSOH, using polystyrene standard and high performance universal chromatographic column, a group of 4 columns (TSKgel G2000HXL, TSKgel G2500HXL, TSKgel G3000HXL and TSKgel G4000HXL, the chromatographic column packing material is a styrene-divinylbenzene copolymer) and a differential refraction detector, using THF as eluent, a flow rate of 1.0 ml/min, a pressure of 6.4 MPa and a column temperature of 40° C.

The isocyanate group (NCO) content is determined by titration according to DIN-EN ISO 11909: 2007-05 and the measured data include free and potentially free NCO content.

The storage stability test of polyisocyanate: The polyisocyanate sample is sealed and stored in a freezer at −5° C. for 10 weeks, and the sample is irradiated with a cold light source to see if the sample is clear or turbid. If the sample is clear, the storage stability is considered to be good, and if the sample is turbid, the storage stability is considered to be poor.

Raw Materials and Reagents

DESMODUR® T 80: toluene diisocyanate, containing about 80 wt % of 2,4-toluene diisocyanate and 20 wt % of 2,6-toluene diisocyanate, commercially available from Covestro Polymer Co., Ltd.

Trimethylolpropane: commercially available from Nantong Baichuan New Materials Co., Ltd.

Diethylene glycol: commercially available from Yangzi Petrochemical-BASF Co., Ltd.

Ethyl acetate: commercially available from Sigma Aldrich (Shanghai) Trading Co., Ltd.

2-Ethyl hexanol: commercially available from Sigma Aldrich (Shanghai) Trading Co., Ltd.

Borchi ® Kat 22: Catalyst, commercially available from OMG Borchers GmbH.

NACURE® 5076: Terminator commercially available from King Industries.

### EXAMPLES AND COMPARATIVE EXAMPLES

### Example 1

800 g DESMODUR® T 80 was previously added into a 1000 mL reaction flask. The flask was heated in an oil bath to 98° C. Within 60 minutes, a premixed polyol mixture consisting of 52 g trimethylolpropane and 28 g diethylene glycol was continuously dosed into the flask to carry out the reaction. The reaction was carried out by stirring at 98° C. for 3 hours to produce a reaction mixture, the excess monomer toluene diisocyanate was removed from the reaction mixture by means of a two-stage thin film distillation (170° C./165° C., p≤0.5 mbar), and then ethyl acetate was added to produce an urethane group-containing polyisocyanate 1.

### Example 2

800 g DESMODUR® T 80 was previously added into a 1000 mL reaction flask. The flask was heated in an oil bath to 95° C. Within 60 minutes, a premixed polyol mixture consisting of 52 g trimethylolpropane and 28 g diethylene glycol was continuously dosed into the flask to carry out the reaction. The reaction was carried out by stirring at 95° C. for 2 hours to produce a reaction mixture, the excess monomer toluene diisocyanate was removed from the reaction mixture by means of a two-stage thin film distillation (170° C./165° C., p≤0.5 mbar), and then ethyl acetate was added to produce an urethane group-containing polyisocyanate 2.

### Example 3

1800 g DESMODUR® T 80 was previously added into a 2000 mL double jacket glass reaction vessel. The vessel was heated to 85° C. Within 250 minutes, a premixed polyol mixture consisting of 166 g trimethylolpropane and 89 g diethylene glycol was continuously dosed into the vessel to carry out the reaction. During the reaction, the reaction heat was removed from the vessel safely by a thermal circulator with heating and cooling functions. The reaction was carried out in an isothermal manner The reaction was carried out by stirring at 85° C. for 2 hours to produce a reaction mixture. Then, the excess monomer toluene diisocyanate was removed from the reaction mixture by means of a two-stage thin film distillation (170° C./165° C., p≤0.5 mbar), and then ethyl acetate was added to produce an urethane group-containing polyisocyanate 3.

### Example 4

A continuous reaction system consisted of four cascade jacket reactors, each reactor having a volume of 400 L. The four cascade reactors were initially changed with DESMODUR® T 80, and the reaction temperatures of four reactors were respectively set at 90° C., 95° C., 95° C. and 95° C. At each of the reactors, the reaction heat released from the reaction was safely removed by means of a cooling and heating temperature control system. The reaction was carried out in an isothermal manner. At the start of the reaction, DESMODUR® T 80 (room temperature) and organic polyhydroxy compounds (60° C.) in a weight ratio of 8.5:1 were continuously dosed into the first reactor of the cascade and the temperature inside the reactor was maintained at 90° C. via the jacket. The organic polyhydroxy compound was a mixture of trimethylolpropane and diethylene glycol in a weight ratio of 65:35. The overall feeding flow rate was controlled in order to maintain the average residence time in in the four cascade reactors of about 1.5 hours. The excess monomer toluene diisocyanate was removed from the reaction mixture by means of a two-stage thin film distillation (170° C./160° C., p≤0.5 mbar), and then ethyl acetate was added to produce an urethane group-containing polyisocyanate 4.

### Example 5

A continuous reaction system consisted of four cascade jacket reactors, each reactor having a volume of 400 L. The four cascade reactors were initially charged with DESMODUR® T 80, and the reaction temperatures of four reactors were respectively set at 90° C., 95° C., 95° C. and 95° C. At each of the reactors, the reaction heat released from the reaction was safely removed by means of a cooling and heating temperature control system. The reaction was carried out in an isothermal manner. At the start of the reaction, DESMODUR® T 80 (room temperature) and organic polyhydroxy compounds (60° C.) in a weight ratio of 8.7:1 were continuously dosed into the first reactor of the cascade and the temperature inside the reactor was maintained at 90° C. via the jacket. The organic polyhydroxy compound was a mixture of trimethylolpropane and diethylene glycol in a weight ratio of 65:35. The overall feeding flow rate was controlled in order to maintain the average residence time in the four cascade reactors of about 1.2 hours. The excess monomer toluene diisocyanate was removed from the reaction mixture by means of a two-stage thin film distillation (170° C./160° C., p≤0.5 mbar), and then ethyl acetate was added to produce an urethane group-containing polyisocyanate 5.

### Example 6

A continuous reaction system consisted of four cascade jacket reactors, each reactor having a volume of 400 L. The four cascade reactors were initially charged with DESMODUR® T 80, and the reaction temperatures of four reactors were respectively set at 85° C., 90° C., 90° C. and 90° C. At each of the reactors, the reaction heat released from the reaction was safely removed by means of a cooling and heating temperature control system. The reaction was carried out in an isothermal manner. At the start of the reaction, DESMODUR® T 80 (room temperature) and organic polyhydroxy compounds (60° C.) in a weight ratio of 8.7:1 were continuously dosed into the first reactor of the cascade and the temperature inside the reactor was maintained at 85° C. via the jacket. The organic polyhydroxy compound was a mixture of trimethylolpropane and diethylene glycol in a weight ratio of 65:35. The overall feeding flow rate was controlled in order to maintain the average residence time in the four cascade reactors of about 1.5 hours. The excess monomer toluene diisocyanate was removed from the reaction solution by means of a two-stage thin film distillation (170° C./160° C., p≤0.5 mbar), and then ethyl acetate was added to produce an urethane group-containing polyisocyanate 6.

### Example 7

1700 g DESMODUR® T 80 was previously added into a 2000 mL double-jacket glass reaction vessel. The vessel was heated to 85° C. Within 45 minutes, a premixed polyol mixture consisting of 110g trimethylolpropane and 60 g diethylene glycol was continuously dosed into the vessel to carry out the reaction. During the reaction, the reaction heat was removed from the vessel safely by a thermal circulator with heating and cooling functions. The reaction was carried out in an isothermal manner The reaction was carried out by stirring at 85° C. for 2 hours to produce a reaction mixture. Then, the excess monomer toluene diisocyanate was removed from the reaction mixture by means of a two-stage thin film distillation (135° C./130° C., p≤0.05 mbar), and then ethyl acetate was added to produce an urethane group-containing polyisocyanate 7.

### Comparative Example 1

1700 g DESMODUR® T 80 was previously added into a 2000 mL double jacket glass reaction vessel. The vessel was heated to 80° C. Within 45 minutes, a premixed polyol mixture consisting of 110 g trimethylolpropane and 60 g diethylene glycol was continuously dosed into the vessel to carry out the reaction. During the reaction, the reaction heat was removed from the vessel safely by a thermal circulator with heating and cooling functions. The reaction was carried out in an isothermal manner The reaction was carried out by stirring at 80° C. for 1 hour to produce a reaction mixture. Then, the excess monomer toluene diisocyanate was removed from the reaction mixture by means of a two-stage thin film distillation (135° C./130° C.; p≤0.05 mbar), and then ethyl acetate was added to produce an urethane group-containing Comparative polyisocyanate 1.

### Comparative Example 2

1411 g DESMODUR® T 80 was previously added into a 2000 mL double jacket glass reaction vessel. The vessel was heated to 85° C. Within 60 minutes, a premixed polyol mixture consisting of 91 g trimethylolpropane and 49 g diethylene glycol was continuously dosed into the vessel to carry out the reaction. During the reaction, the reaction heat was removed from the vessel safely by a thermal circulator with heating and cooling functions. The reaction was carried out in an isothermal manner The reaction was carried out by stirring at 85° C. for 1 hour to produce a reaction mixture. The obtained reaction mixture was heated to about 98° C. 0.26 g Borchi® Kat 22 solution (10 wt % in 2-ethyl hexanol) was added, and the reaction was carried out by stirring at 98° C. for 1 hour. 0.17 g NACURE® 5076 was added, and stirred for 1 hour. Then, the excess monomer toluene diisocyanate was removed by means of a two-stage thin film distillation (127° C./140° C.; p≤0.05 mbar), and then ethyl acetate was added to produce an urethane group-containing Comparative polyisocyanate 2.

Polyisocyanate Specifications and Storage Stability Test Results

Table 1 lists the specifications and storage stability test results for polyisocyanates 1-7 and comparative polyisocyanates 1-2.

TABLE 1
Specifications and Storage Stability Test of Polyisocyanates

| | Polyisocyanate specifications | | | | | |
|---|---|---|---|---|---|---|
| | Isocyanate | | Unreacted | | | |
| Example/ | group | Solid | excess | | Ratio of | Storage |
| Comparative | content/ | content/ | TDI monomer | Viscosity/ | integrated | stability |
| Example | wt % | wt % | content/wt % | mPa · s | areas | test |
| polyisocyanate | 14.3 | 74.6 | 0.32 | 2340 | 2.6 | Clear |
| 1 | | | | | | |
| polyisocyanate | 13.4 | 74.5 | 0.20 | 1850 | 4.6 | Clear |
| 2 | | | | | | |
| polyisocyanate | 13.2 | 75.2 | 0.35 | 1649 | 6.7 | Clear |
| 3 | | | | | | |
| polyisocyanate | 13.2 | 74.2 | 0.28 | 1562 | 7.0 | Clear |
| 4 | | | | | | |
| polyisocyanate | 13.4 | 74.9 | 0.31 | 1330 | 9.2 | Clear |
| 5 | | | | | | |
| polyisocyanate | 13.5 | 76.3 | 0.34 | 1784 | 11.7 | Clear |
| 6 | | | | | | |
| polyisocyanate | 13.9 | 75.0 | 0.21 | 854 | 13.0 | Clear |
| 7 | | | | | | |
| Comparative | 13.6 | 74.4 | 0.30 | 889 | 14.2 | Turbid |
| polyisocyanate | | | | | | |
| 1 | | | | | | |
| Comparative | 15.5 | 74.3 | 0.36 | 2650 | 1.6 | Clear |
| polyisocyanate | | | | | | |
| 2 | | | | | | |

Note:
The ratio of the integral area refers to the ratio of the integral area of the component peaks having a weight-average molecular weight of 800 ± 50 g/mol to the integral area of the shoulder peaks having a weight-average molecular weight of 950 ± 50 g/mol in the GPC measured with the gel chromatograph.

It can be seen from Examples 1-7 that the polyisocyanate of the present invention not only has a high content of isocyanate groups, a low content of monomeric toluene diisocyanate and a low viscosity, but also has good storage stability. It can be seen from Comparative Example 1 that, when the ratio of the integral area of the component peaks having a weight-average molecular weight of 800±50 g/mol to the integral area of the shoulder peaks having a weight-average molecular weight of 950±50 g/mol in the gel chromatogram of the comparative polyisocyanate is higher than 14, the comparative polyisocyanate has poor storage stability. It can be seen from Comparative Example 2 that, when the ratio of the integral area of the component peaks having a weight-average molecular weight of 800±50 g/mol to the integral area of the shoulder peaks having a weight-average molecular weight of 950±50 g/mol in the GPC of the comparative polyisocyanate is less than 2 obtained by adding a Borchi® Kat 22 solution, although the storage stability of the comparative polyisocyanate is improved, the viscosity of the comparative polyisocyanate is more than 2500 mPa·s, which is disadvantageous for practical industrial applications.

In comparison of Examples 2-6 with Examples 1 and 7, when the viscosity of the polyisocyanate is not higher than 2000 mPa·s, and the ratio of the integral area of the component peaks having a weight-average molecular weight of 800±50 g/mol to the integral area of the shoulder peaks having a weight-average molecular weight of 950±50 g/mol is 4-12, the polyisocyanate has good storage stability and is more in line with the desired low viscosity requirements in the industry. As shown in Examples 3-6, when the viscosity of the polyisocyanate is not higher than 1800 mPa·s, and the ratio of the integral area of the component peaks having a weight-average molecular weight of 800±50 g/mol to the integral area of the shoulder peaks having a weight-average molecular weight of 950±50 g/mol is 6-12, the polyisocyanate has good storage stability and is more popular in the industry.

It is apparent to those skilled in the art that the present invention is not limited to the specific details described above, and the present invention may be embodied in other specific forms without departing from the spirit or essential characteristics of the invention. The examples disclosed in the present application are therefore to be considered as illustrative and non-limiting from all respects, and therefore the scope of the invention is indicated by the claims rather than the description. Therefore, any change, as long as it falls within the meaning and scope of the claim or its equivalents, should be considered as the invention.

1. A urethane group-containing polyisocyanate comprising a reaction product of an organic polyhydroxy compound and excess toluene diisocyanate, wherein the organic polyhydroxy compound contains trimethylolpropane and optional di- to tetra-hydric alcohols having a molecular weight of 62-146 g/mol, wherein the polyisocyanate has the following characteristics:
a. the ratio of the integral area of the component peaks having a weight-average molecular weight of 800±50 g/mol to the integral area of the shoulder peaks having a weight-average molecular weight of 950±50 g/mol is 2-14; and
b. the viscosity is not higher than 2500 mPa·s,
wherein the polyisocyanate component and the weight-average molecular weight thereof are determined according to DIN 55672-1:2016-03 with a HLC-8320 EcoSEC-type gel chromatograph from TOSOH, using polystyrene standard and high performance universal chromatographic column, a group of 4 columns (TSKgel G2000HXL, TSKgel G2500HXL, TSKgel G3000HXL and TSKgel G4000HXL, the chromatographic column packing material is a styrene-divinylbenzene copolymer) and a differential refraction detector, using THF as eluent, a flow rate of 1.0 ml/min, a pressure of 6.4 MPa and a column temperature of 40° C., and
wherein the viscosity of the polyisocyanate component is measured according to DIN EN ISO 5:1994-10 using a cone/plate measuring instrument at 23° C.

2. The urethane group-containing polyisocyanate according to claim 1, wherein the ratio of the integral area of the component peaks having a weight-average molecular weight of 800±50 g/mol to the integral area of the shoulder peaks having a weight-average molecular weight of 950±50 g/mol is 3-13.

3. The urethane group-containing polyisocyanate according to claim 1, wherein the viscosity of the polyisocyanate is not higher than 2000 mPa·s.

4. The urethane group-containing polyisocyanate according to claim 1, wherein the polyisocyanate further has one or more of the following characteristics:
c. the solid content is not lower than 50 wt % and not higher than 90 wt %;
d. the amount of the unreacted excess toluene diisocyanate is not higher than 0.5 wt %; and
e. the isocyanate group content is 13 wt %-15 wt %;
wherein all of the weight percent numbers are based on the total weight of the polyisocyanate being 100 wt %.

5. The urethane group-containing polyisocyanate according to claim 1, wherein the total weight of the trimethylolpropane and the optional di- to tetra-hydric alcohols having a molecular weight of 62-146 g/mol are 99.7 wt %-100 wt %, based on the total weight of the organic polyhydroxy compound being 100 wt %.

6. The urethane group-containing polyisocyanate according to claim 1, wherein the weight ratio of the trimethylolpropane to the di- to tetra-hydric alcohols having a molecular weight of 62-146 g/mol is 1:4-4:1.

7. The urethane group-containing polyisocyanate according to claim 1, wherein the di- to tetra-hydric alcohols having a molecular weight of 62-146 g/mol are selected from the group consisting of ethylene glycol, diethylene glycol, 1,2-propylene glycol, 1,3-propylene glycol, 1,2-butylene glycol, 1,3-butylene glycol, 1,4-butylene glycol, 1,5-pentylene glycol, neo-pentylene glycol, 1,6-hexylene glycol, 2-ethyl hexylene glycol, glycerol, and pentaerythritol.

8. The urethane group-containing polyisocyanate according to claim 1, wherein the di- to tetra-hydric alcohol having a molecular weight of 62-146 g/mol is diethylene glycol, and the weight ratio of trimethylolpropane to diethylene glycol is 1:4-4:1.

9. The urethane group-containing polyisocyanate according to claim 1, which is characterized wherein the reaction product further contains isocyanate compounds different from the toluene diisocyanate, the weight ratio of the toluene diisocyanate to the isocyanate compounds different from the toluene diisocyanate is not lower than 60:40.

10. The urethane group-containing polyisocyanate according to claim 1, wherein the toluene diisocyanate is a mixture of 2,4-toluene diisocyanate and 2,6-toluene diisocyanate in a weight ratio of 60:40-95:5.

11. A process for preparing the urethane group-containing polyisocyanate according to claim 1, the process comprising,
i. reacting a system containing organic polyhydroxy compounds and excess toluene diisocyanate to produce a pre-polymer reaction mixture, the reaction temperature is 85° C.-120° C., for 1 hour to 24 hours;
ii. removing the unreacted toluene diisocyanate by separation from the pre-polymer reaction mixture obtained in step i; and
iii. adding organic solvents to dilute and to produce the urethane group-containing polyisocyanate.

12. The process according to claim 11, wherein in step i, the reaction temperature is 85° C.-110° C.

13. The process according to claim 11, wherein in step i, the reaction time is 1.2 hours to 7 hours.

14. The process according to claim 11, wherein the equivalent ratio of the isocyanate group to the hydroxy group of the system is 3:1-20:1.

15. A product containing the urethane group-containing polyisocyanate according to claim 1.

16. The product according to claim 15, wherein the product is selected from a group consisting of a polyurethane paint and a polyurethane adhesive.

17. The product according to claim 16, wherein the product is a polyurethane paint.

18. The product according to claim 16, wherein the product is a polyurethane adhesive.
